(19) United States
(12) Patent Application Publication
(10) Pub. No.: US 2007/0204718 A1
(43) Pub. Date: Sep. 6, 2007

(54) Self presenting electronic shifter

(76) Inventors: Daniel Lee Strait, Davison, MI (US); Michael Lee Stenzel, Holly, MI (US)

Correspondence Address: PORTER WRIGHT MORRIS & ARTHUR LLP;Attorneys & Counselors at Law, 41 South High Street, Columbus, OH, 43215-6194, US

(21) Appl. No.: 11/369,111

(22) Filed: Mar. 6, 2006

(51) Int. Cl. G05G 1/04

(52) U.S. Cl. 74/523

(57) ABSTRACT

A shifter assembly includes an electronic shifter mechanism having a shift lever movable between a plurality of gear positions and an electrically powered drive system operatively connected to the shifter mechanism to selectively move the shifter mechanism between a first location wherein the shifter lever is located substantially within a housing and a second location wherein the shifter lever is located substantially outside the housing. The drive system moves the shifter mechanism along a vertical, linear path substantially parallel to a longitudinal axis of the shift lever such that the shift lever moves through an opening in the housing.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a shifter mechanism for controlling transmissions of motor vehicles and, more particularly, a shifter mechanism that moves between a stowed position and an operating position.

### BACKGROUND OF THE INVENTION

In a motor vehicle equipped with a transmission, there is typically a shifter mechanism that includes a shift lever pivotable over a series of positions representative of desired transmission gears. The shifter mechanism is connected to the motor vehicle automatic transmission by a suitable mechanical and/or electronic operating linkage to effect actuation of the transmission to the selected gear when the shifter lever is pivoted to the transmission gear's representative position.

Many shifter mechanisms are floor or console type shifter mechanisms that is positioned between the driver's seat and the front passenger seat. The shift lever typically extends generally upward from the vehicle floor or a center console. This type of shifter mechanism makes it difficult for a person to move between the driver's seat and the front passenger seat as needed in some instances such as when the vehicle is parked near heavy traffic or in a very narrow parking space. Movement is difficult because the upward extending shift lever becomes an obstruction. Additionally, this type of shifter mechanism can be inadvertently shifted during movement of the driver or the front passenger. As a result, such shifter mechanism must have interlocks, detents, etc. that make inadvertent shifting less likely.

One solution to this problem has been to provide the shift lever with a hinge so that the shift lever can be folded to a stowed position. See U.S. Pat. Nos. 4,073,199, 4,281,526, 4,732,232, 4,823,635, 5,328,285, 6,029,535 and 6,240,803, the disclosures of which are expressly incorporated herein in their entireties by reference, for examples of folding gear shift levers. While these folding gear shift levers may permit stowing of the gear shift levers, they can be complicated and expensive to produce in a manner such that the shift lever does not inadvertently fold during operation of the motor vehicle. Additionally, these folding gear shift levers cane be cumbersome to operate and are aesthetically unpleasing. Furthermore, there is an unending desire in the motor vehicle industry to reduce cost and complexity and to increase safety and aesthetics. Accordingly, there is a need in the art for an improved shifter mechanism.

### SUMMARY OF THE INVENTION

The present invention provides a shifter mechanism which overcomes at least some of the above-noted problems of the related art. According to the present invention, a shifter assembly comprises, in combination, a shifter mechanism having a shift lever movable between a plurality of gear positions and a drive system operatively connected to the shifter mechanism to selectively move the shifter mechanism between a first location wherein the shift lever is inoperative and a second location wherein the shift lever is operative.

According to another aspect of the present invention, a shifter assembly comprises, in combination, an electronic shifter mechanism having a shift lever movable between a plurality of gear positions, and a drive system operatively connected to the shifter mechanism to selectively move the shifter mechanism between a first location wherein the shifter lever is located substantially within a housing and a second location wherein the shifter lever is located substantially outside the housing.

According to yet another aspect of the present invention, a shifter assembly comprises, in combination, an electronic shifter mechanism having a shift lever movable between a plurality of gear positions, and an electrically powered drive system operatively connected to the shifter mechanism to selectively move the shifter mechanism between a first location wherein the shifter lever is located substantially within a housing and a second location wherein the shifter lever is located substantially outside the housing. The drive system moves the shifter mechanism along a vertical, linear path substantially parallel to a longitudinal axis of the shift lever such that the shift lever moves through an opening in the housing.

From the foregoing disclosure and the following more detailed description of various preferred embodiments it will be apparent to those skilled in the art that the present invention provides a significant advance in the technology and art of motor vehicle shifter mechanisms. Particularly significant in this regard is the potential the invention affords for providing a high quality, reliable, low cost, easily adjusted assembly having reduced package size and pleasing aesthetics. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a shifter assembly according to a preferred embodiment of the present invention wherein a shift lever is in a stowed or retracted position and components are removed for clarity;

FIG. 2 is a perspective view of a shifter assembly of FIG. 1, wherein the shift lever is in an operating or extended position; and

FIG. 3 is a schematic view of the shifter assembly of FIGS. 1. and 2.

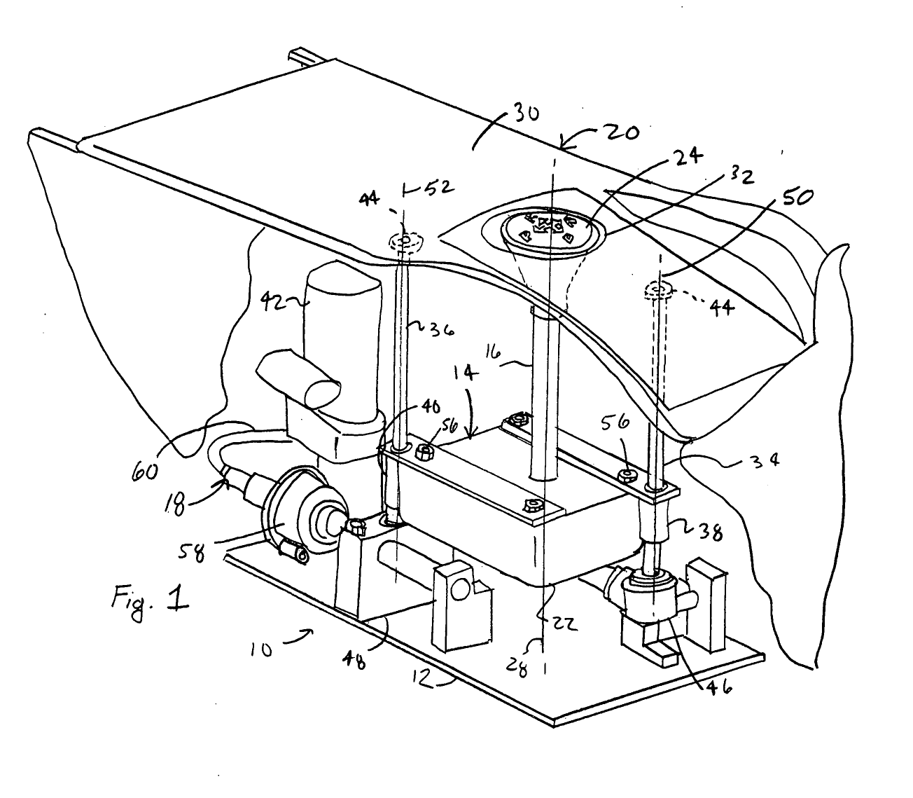

It should be understood that the appended drawings are not necessarily to scale, presenting a somewhat simplified representation of various preferred features illustrative of the basic principles of the invention. The specific design features of the shifter assembly as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter assembly illustrated in the drawings. In general, up or upward generally refers to an upward direction within the plane of the paper in FIG. 1 and down or downward generally refers to a downward direction within the plane of the paper in FIG. 1. Also in general, fore or forward refers to a direction toward the front of the motor vehicle, that is, generally toward the left in FIG. 1 and aft or rearward refers to a direction toward the rear of the motor vehicle, that is, generally toward the right in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved shifter assembly disclosed herein. The following detailed discussion of various alternative and preferred embodiments will illustrate the general principles of the invention with reference to a shifter mechanism for a motor vehicle such as an automobile, sport utility vehicle (SUV), crossover vehicle, or the like. Other embodiments suitable for other applications will be apparent to those skilled in the art given the benefit of this disclosure.

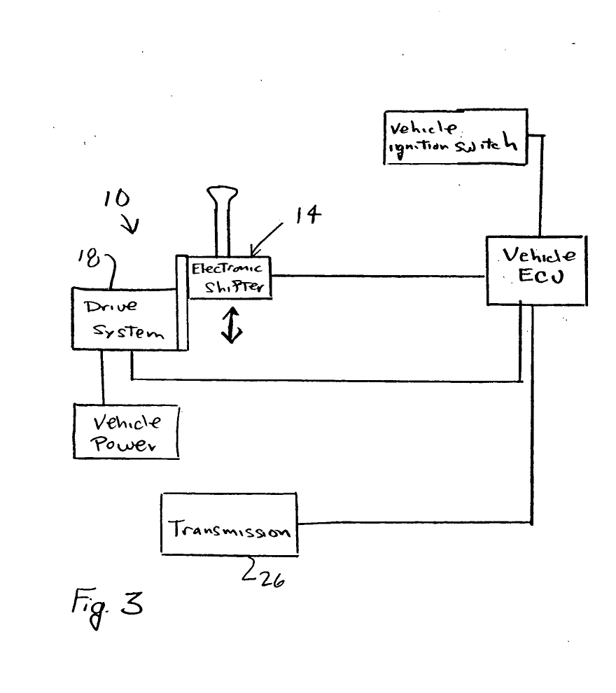

Referring now to the drawings, FIGS. 1 to 3 show a shifter assembly 10 according to a preferred embodiment of the present invention. The illustrated shifter assembly 10 includes a frame or base 12, a shifter mechanism 14 including a shift arm or lever 16 pivotable to a plurality of gear positions; and a powered translator or drive system 18 for moving the shifter mechanism 14 from a stowed or retracted location wherein the shift lever 16 is located in an inoperable position substantially within a housing or center console 20 and an operative or extended location wherein the shift lever 16 is located in an operable position extending substantially upward from the center console 20.

The base 12 is adapted to be attached to the motor vehicle in a fixed position such as a floor or console 20 and can be formed of any suitable size and shape. The illustrated base 12 is generally planar and shaped to engage the motor vehicle in a desired manner. The base 12 can be attached in a fixed position relative to the motor vehicle in any suitable manner. Other suitable shapes for the base 12 will be apparent to those skilled in the art. The base 12 can be formed of any suitable material such as, for example, metal, plastic or the like.

The illustrated shifter mechanism 14 includes a housing 22 and the shift lever 16 which upwardly extends from the housing 22. The illustrated housing 22 is generally rectangular shaped but any suitable housing, base, bracket, or the like can be utilized. The shift lever 16 pivotable relative to the housing 22 between a plurality of gear positions. The upper end of the illustrated shift lever 16 is provided with handle or knob 24 for grasping by the driver. The illustrated shifter mechanism 14 includes gear positions of park P, drive D, neutral N, and reverse R but any other suitable plurality of gear positions can be utilized within the scope of the present invention. The illustrated shifter mechanism 14 is an electronic shifter mechanism that is, the shifter mechanism 14 is connected to the motor vehicle transmission 26 by a suitable electronic operating linkage to effect actuation of the transmission 26 to the selected gear when the shifter lever 16 is pivoted to the transmission gear's representative position. Thus, the shifter mechanism 14 is connected by electric wires and/or cables or a suitable wireless electronic connection to the transmission 26 and sends electric signals via the connection as to the selected position of the shift lever 16. It is noted, however, that the shifter mechanism 14 can alternatively be of any other suitable type.

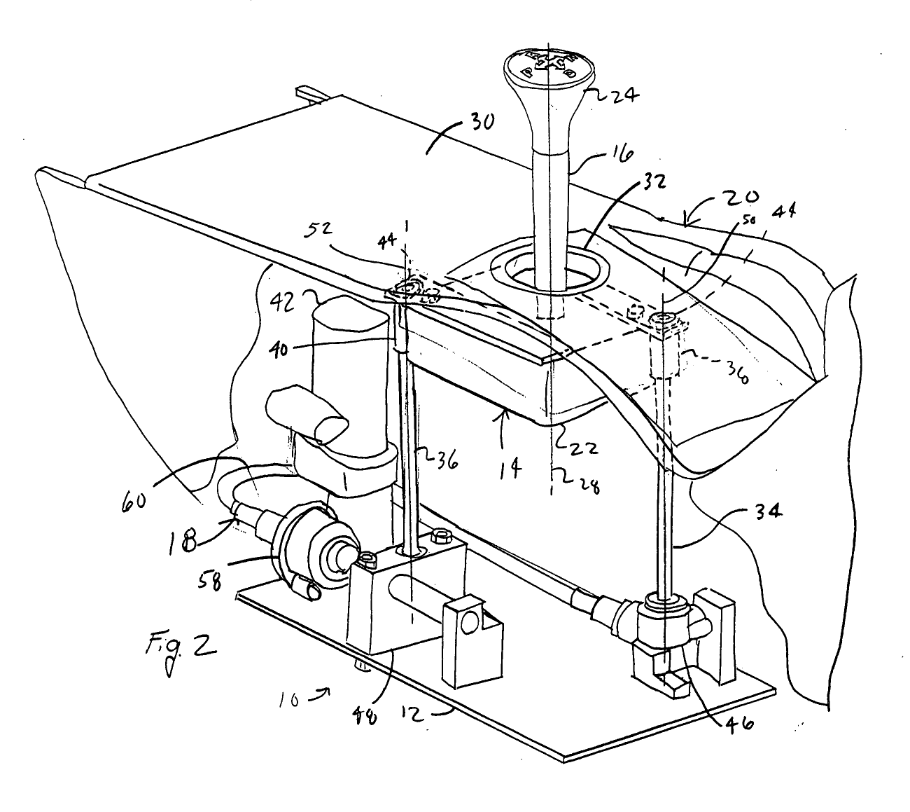

The drive system 18 selectively moves the shifter mechanism 14 between the stowed or retracted location and the operative or extended location. The illustrated shifter mechanism 14 is vertically moved along a linear path that is substantially parallel with a longitudinal axis 28 of the shift lever 16. It is noted, however, that the shifter mechanism 14 can alternatively be moved along other directions and other shaped paths. In the stowed position, the illustrated shifter lever 16 is substantially below a top wall 30 of the console 20. Only a top portion of the shift lever knob 24 remains exposed within an opening 32 in the console top wall 30 (best shown in FIG. 1). In this position, the driver cannot pivot the shift lever 16 between the plurality of gear positions because it is within the console 20. When activated, the drive system 18 raises the shift mechanism 14 from the stowed position to the operative position so that the shift lever 16 is located substantially above the console top wall 30 (best shown in FIG. 2). In this position, the driver can pivot the shift lever 16 between the plurality of gear positions because the shift lever 16 is located adequately above the console 20.

The illustrated drive system 18 includes a pair of spaced-apart, parallel guide rods or members 34, 36, a pair of guides 38, 40 cooperatively receiving the guide rods 34, 36, and an electric motor 42. The illustrated guide rods 34, 36 are generally elongate and oriented in a vertical direction. Upper ends of the illustrated guide rods 34, 36 are provided with stops 44. The first guide rod 34 is secured to the base via a gear assembly 46 and the second guide rod 36 is secured to the base via a mounting block or bracket 48. The illustrated first guide rod 34 is rotatable about its vertically extending central longitudinal axis 50 and is provided with a screw thread to cooperate with the first guide 38 as described in more detail hereinafter. The illustrated second guide rod 36 is not rotatable about its vertically extending central longitudinal axis 52 and is sized and shaped to cooperate with the second guide 40 as described in more detail hereinafter. It is noted that both guide rods 34, 36 can be rotatable and have screw threads when desired and/or there can be more than two of the guide rods 34, 36 when desired.

The illustrated first and second guides 38, 40 each include a plate or attachment portion secured to the top of the shifter mechanism housing 22. The plate portions are rigidly secured to the shifter mechanism housing by suitable means such as the illustrated mechanical fasteners 56. The plate portions extend beyond opposite ends of the housing 22 and have engagement portions downwardly extending therefrom. The first engagement portion includes a vertically extending threaded opening adapted to cooperate with the first guide rod 34 so that rotation of the guide rod 34 vertically moves the first guide 38, and the shifter mechanism 14 rigidly secured thereto, along the length of the first guide rod 34. The second engagement portion includes a vertically extending opening adapted to cooperate with the second guide rod 36 so that the second engagement portion vertically moves along the length of the second guide rod 36 as the shifter mechanism 14 vertically moves. The opening of the second engagement portion is sized and shaped to closely receive the second guide rod 36. The illustrated opening and guide rod 36 are circular but any other suitable shape can alternatively be utilized.

The illustrated electric motor 42 is a two-direction DC motor and is operatively connected to vehicle power. The electric motor 42 is secured to the base 12 by suitable means. The illustrated motor 42 is provided with a suitable speed-reduction gear assembly 58. An output shaft of the gear assembly 58 is operatively connected to an input shaft of the gear assembly 46 of the first guide rod 34 so that rotation of the drive motor 42 rotates the first guide rod 42. The illustrated connection includes a flex cable or shaft 60, such as a Bowden cable, but alternatively any other suitable type of connection can be utilized. The illustrated gear assembly 58 is adapted to convert the rotation of the horizontally extending input shaft into rotation of the vertically extending first guide rod 34. It is noted that any suitable type of gear assembly 58 can be utilized and in some embodiments may be eliminated. When the drive motor 42 is operated in one direction, the first guide rod 34 is rotated in one direction to raise the shifter mechanism 14 and when the drive motor 42 is operated in the other direction, the first guide rod 34 is rotated in the other direction to lower the shifter mechanism 14. It is noted that any other suitable type of drive system 18 can be utilized such as, for example, a rack and pinion, a linear actuator, a scissors mechanism, or the like.

As best shown, in FIG. 1, when the shifter mechanism 14 is in its first or stowed position, the shift lever 16 is located substantially below the console top wall 30 so that the shift mechanism 14 is substantially inside the console 22 and hidden or out of view and is not operative. Upon activation of the drive system 18, the shifter mechanism 14 is vertically moved to its second or operative position. The illustrated drive system 18 upwardly moves the shifter mechanism 14 along a linear path so that the shift lever 6 linearly moves through the opening 32 in the console top wall 30. Preferably, the drive system 18 is automatically activated upon predetermined conditions such as, for example, activation of the vehicle ignition switch 62 or the presence of a key in the ignition switch 62 but any other suitable conditions can be utilized. It is noted that additionally or alternately an operator input switch can be provided so that the driver can selectively active the drive system 18.

As best shown in FIG. 2 when the shifter mechanism 14 is in its second or operative position, the shift lever 16 is located substantially above the console top wall 30 so that the shift mechanism 14 is substantially outside the console 20 and in view and is operative. Upon activation of the drive system 18, the shifter mechanism 14 is vertically moved to its first or stowed position. The illustrated drive system 18 downwardly moves the shifter mechanism 14 along a linear path so that the shift lever 16 linearly moves through the opening 32 in the console top wall 30. Preferably, the drive system 18 is automatically activated upon predetermined conditions such as, for example, deactivation of the vehicle ignition switch 62 or the removal of a key from the ignition switch 62 but any other suitable conditions can be utilized. It is noted that additionally or alternately an input switch can be provided so that the driver can selectively active the drive system 18.

It is apparent from the above detailed description of preferred embodiments of the present invention, that the shifter assembly 10 provides large advances over the prior art. The shifter assembly 10 provides a sleek and uninterrupted style and lessens the possibility of damage to the shifter mechanism 14. The shifter assembly 10 also prevents or reduces the possibility of accidental or inadvertent shifting of the shift lever 16. The shifter assembly also utilizes a shift lever 16 that is of rigid, non-folding construction to reduce cost and complexity and inadvertent collapse of the shift lever 16.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shifter assembly comprising, in combination:
a shifter mechanism having a shift lever movable between a plurality of gear positions; and
a drive system operatively connected to the shifter mechanism to selectively move the shifter mechanism between a first location wherein the shift lever is inoperative and a second location wherein the shift lever is operative.

2. The shifter assembly according to claim 1, wherein the shifter mechanism is an electronic shifter mechanism.

3. The shifter assembly according to claim 1, wherein drive system is electrically powered.

4. The shifter assembly according to claim 4, wherein drive system include an electric motor.

5. The shifter assembly according to claim 4, wherein the drive system automatically moves the shifter mechanism according to predetermined conditions.

6. The shifter assembly according to claim 1, wherein the shifter mechanism moves along a linear path between the first and second locations.

7. The shifter assembly according to claim 5, wherein shifter mechanism moves vertically between the first and second locations.

8. The shifter assembly according to claim 1, wherein the shifter lever is located substantially within a housing when in the first location and the shifter lever is located substantially outside the housing when in the second location.

9. The shifter assembly according to claim 8, wherein the shift lever moves through an opening in the housing when moving between the first and second location.

10. The shifter assembly according to claim 1, wherein the shifter lever moves parallel to a longitudinal axis of the shift lever.

11. A shifter assembly comprising, in combination:
an electronic shifter mechanism having a shift lever movable between a plurality of gear positions; and
a drive system operatively connected to the shifter mechanism to selectively move the shifter mechanism between a first location wherein the shifter lever is located substantially within a housing and a second location wherein the shifter lever is located substantially outside the housing.

12. The shifter assembly according to claim 11, wherein drive system is electrically powered.

13. The shifter assembly according to claim 12, wherein drive system include an electric motor.

14. The shifter assembly according to claim 12, wherein the drive system automatically moves the shifter mechanism according to predetermined conditions.

15. The shifter assembly according to claim 11, wherein the shifter mechanism moves along a linear path between the first and second locations.

16. The shifter assembly according to claim 15, wherein shifter mechanism moves vertically between the first and second locations.

17. The shifter assembly according to claim 11, wherein the shift lever moves through an opening in the housing when moving between the first and second locations.

18. The shifter assembly according to claim 11, wherein the shifter lever moves parallel to a longitudinal axis of the shift lever.

19. The shifter assembly according to claim 1, wherein shifter mechanism is inoperative in the first location and is operative in the second location.

20. A shifter assembly comprising, in combination:
an electronic shifter mechanism having a shift lever movable between a plurality of gear positions;
an electrically powered drive system operatively connected to the shifter mechanism to selectively move the shifter mechanism between a first location wherein the shifter lever is located substantially within a housing and a second location wherein the shifter lever is located substantially outside the housing; and
wherein the drive system moves the shifter mechanism along a vertical, linear path substantially parallel to a longitudinal axis of the shift lever such that the shift lever moves through an opening in the housing.
